(19) United States
(12) Patent Application Publication
(10) Pub. No.: US 2026/0009584 A1
(43) Pub. Date: Jan. 8, 2026

(54) COOLING ARRANGEMENT AND METHOD FOR COOLING AT LEAST ONE OIL-TO-AIR EXTERNAL HEAT EXCHANGER

(71) Applicant: Hitachi Energy Ltd, Zürich (CH)

(72) Inventors: Rebei Bel Fdhila, Västerås (SE); Ulf Sand, Västerås (SE); Lokman Hosain, Västerå (SE)

(21) Appl. No.: 19/129,690

(22) PCT Filed: Nov. 21, 2023
(86) PCT No.: PCT/EP2023/082572

§ 371 Date: May 14, 2025

(30) Foreign Application Priority Data
Nov. 22, 2022 (EP) 22208856.9

(51) Int. Cl. F28D 1/02; F28D 21/00; H01F 27/12

(52) U.S. Cl. CPC F28D 1/02; H01F 27/12; F28D 2001/0253; F28D 2021/0031

(57) ABSTRACT

A cooling arrangement for cooling at least one OAEHE in a transformer. The cooling arrangement comprises at least one impeller-motor device, at least one fluid pipe and a first fluid discharge device. The first fluid discharge device comprises a fluid inlet arranged to receive a fluid from the at least one fluid pipe, and at least one fluid outlet arranged to direct the fluid towards the OAEHE, wherein the at least one impeller-motor device is adapted to supply the fluid to the inlet of the first fluid discharge device via the at least one fluid pipe and cause the fluid to flow through the at least one fluid outlet of the first fluid discharge device in a direction of the at least one OAEHE. The cooling arrangement further comprises a second fluid discharge device adapted to disturb the fluid that flows through the at least one fluid outlet of the first fluid discharge device.

### CROSS-REFERENCE TO RELATED APPLICATIONS

This application is a 35 U.S.C. § 371 national stage application of PCT International Application No. PCT/EP2023/082572 filed on November 21, 203, which in turns claims foreign priority to European Patent Application No. 22208856.9, filed on Nov. 22, 2022, the disclosures and content of which are incorporated by reference herein in their entireties.

### TECHNICAL FIELD

Embodiments herein relate to the field of transformers. In particular, the embodiments herein relate to a cooling arrangement for cooling at least one oil-to-air external heat exchanger (OAEHE) in a transformer.

### BACKGROUND

A power transformer is equipment used in an electric grid of a power system. Power transformers transform voltage and current in order to transport and distribute electric energy. Power transformers involve high currents; therefore, production of heat is inevitable. This heat propagates in the oil inside a transformer tank. It is important to release this heat to the surroundings for the normal operation of transformers. An important part of oil-cooling is carried out by placing external devices, such as radiators, cooler banks etc., through which the transformer oil is circulated and get cooled. State-of-the art air-cooling for a transformer is performed using conventional fans, i.e., bladed fans, or natural convection. The state-of-the-art cooling of using standard fans produces high noise, has complex structure, is heavy and of difficult maintenance. For high power rated transformers, natural convection is not enough, and therefore, forced cooling is needed for this operation.

External transformer cooling is generally obtained through a battery of radiators allowing the oil to circulate externally from top to bottom. The cooling process is performed by ambient air as natural or forced convection. This disclosed subject matter is concerning the forced convection cases which is generally provided by a set of large fans blowing air through the radiators. The efficiency of the cooling is dependent on the air flow rate and consequently on the power consumption of the fans which is an operation heavy cost that would be useful to strongly decrease.

The present disclosure presents an improved viable solution of a cooling arrangement.

### SUMMARY

As part of developing embodiments herein one or more problems have been identified. By replacing the conventional fans by bladeless fans where the air is blown from a remote impeller and injected through an air multiplier, the power consumption and the noise level can be reduced since the impeller noise can be easily controlled. However, the bladeless fan comprising a linear (circular, rectangular or other shape) thin slot cannot provide a uniform flow to cool all the hot surfaces. Assuming the bladeless fan is a ring, the generated jet then has approximately a cylindrical shape with low speed in the core and much higher speed at the edges. The cooling pattern will be far from being uniform with some panels' surfaces having high heat transfer coefficient and others not at all. Panels' areas submitted to very low air speed will not perform sufficient cooling and hot oil will be re-injected to the transformer tank.

It is an object of embodiments herein to enhance cooling of an OAEHE of a transformer.

According to an aspect the object is achieved by providing a cooling arrangement for cooling at least one OAEHE in a transformer. The cooling arrangement comprises at least one impeller-motor device, at least one fluid pipe, and a first fluid discharge device. The first fluid discharge device comprises a fluid inlet arranged to receive a fluid from the at least one fluid pipe, and at least one fluid outlet arranged to direct the fluid towards the OAEHE. The at least one impeller-motor device is adapted to supply the fluid to the inlet of the first fluid discharge device via the at least one fluid pipe and cause the fluid to flow through the at least one fluid outlet of the first fluid discharge device in a direction of the at least one OAEHE. The cooling arrangement further comprises a second fluid discharge device adapted to disturb the fluid that flows through the at least one fluid outlet of the first fluid discharge device.

According to some embodiments, the second fluid discharge device may disturb the fluid that flows through the at least one fluid outlet of the first fluid discharge device by destabilizing and/or widen the fluid by applying a cross flow jet.

According to some embodiments, the applied cross flow jet may be continuous.

According to some embodiments, the applied cross flow jet may be pulsating.

According to some embodiments, the at least one impeller-motor device may be adapted to supply the fluid to the second discharge device.

According to some embodiments, the second fluid discharge device may be located between the first fluid discharge device and the at least one OAEHE.

According to some embodiments, a diameter of the second fluid discharge device may be smaller than or the same size as a diameter of the first fluid discharge device, and wherein the cross flow jet may be applied outwards from the second fluid discharge device.

According to some embodiments, a diameter of the second fluid discharge device may be larger than a diameter of the first fluid discharge device, and wherein the cross flow jet may be applied inwards of the second fluid discharge device.

According to some embodiments, the cooling arrangement may comprise a funnel. According to some embodiments, the at least one fluid discharge device and/or the second fluid discharge device may be arranged in the funnel.

According to another aspect the above-mentioned object is also achieved by providing a method performed by a cooling arrangement for cooling at least one OAEHE in a transformer. The cooling arrangement comprises at least one impeller-motor device, at least one fluid pipe and a first fluid discharge device. The first fluid discharge device comprises a fluid inlet for receiving a fluid flow from the at least one fluid pipe, and at least one fluid outlet. The cooling arrangement supplies the fluid into the at least one fluid pipe, using the at least one impeller-motor device. The cooling arrangement further transports the fluid along the at least one fluid pipe to the inlet of the at least one fluid discharge device. The cooling arrangement further causes the fluid to flow through the at least one fluid discharge device. The cooling arrangement then further discharges the fluid through the at least one fluid outlet in a direction of the at least one OAEHE. The cooling arrangement further comprises a second fluid discharge device. The cooling arrangement disturbs the fluid that flows through the at least one fluid outlet of the first fluid discharge device, using the second fluid discharge device.

Embodiments herein are based on the realisation that by providing a second fluid discharge device that disturbs the fluid that flows from the first fluid discharge device, fluid velocity differences of the fluid that flows from the first discharge device is reduced and an improved redistribution of the fluid flow is allowed. Thereby the cooling arrangement effectively provides a powerful and enhanced cooling of at least one OAEHE of a transformer.

### BRIEF DESCRIPTION OF THE FIGURES

Further technical features of the present disclosure will become apparent through the following description of one or several exemplary embodiments given with reference to the appended figures, where:

FIG. 1 is a schematic overview depicting a cooling arrangement, according to embodiments herein;

FIG. 2a is a schematic overview depicting fluid that flows from a first fluid discharge device without any disturbance of fluid;

FIG. 2b is a schematic overview depicting fluid that flows from a first fluid discharge device with disturbance of fluid; and

FIG. 3 is a flowchart depicting a method performed by a cooling arrangement according to embodiments herein.

It should be noted that the drawings have not necessarily been drawn to scale and that the dimensions of certain elements may have been exaggerated for the sake of clarity.

### DETAILED DESCRIPTION

Embodiments herein introduce cross flow jets, e.g., from pipes or slots perpendicular to a fluid from a fluid discharge device, such as a main bladeless fan jet, to break it or destabilize it to become wider and cover more radiator surfaces. The cross jets, which also may be called control jets, may be continuous or pulsating when an intermittent or transient cooling is desired. The fluid, e.g., jet, intensity, quality, and position may be optimized using computational fluid dynamic simulations.

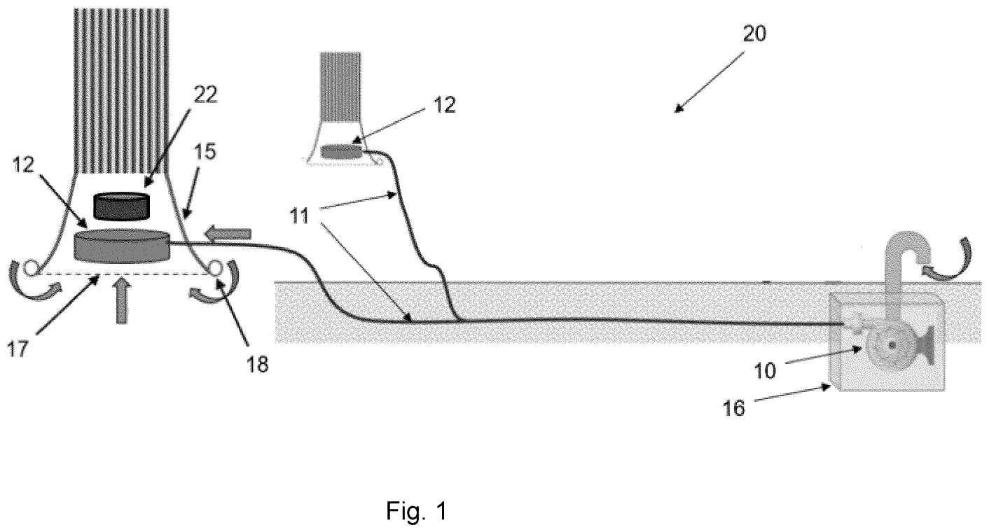

An integrated description and operation of a cooling arrangement 20 according to embodiments herein is illustrated in FIG. 1. The cooling arrangement 20 comprises at least one impeller-motor device 10, at least one fluid pipe 11 and a first fluid discharge device 12. The first fluid discharge device 12 may be hollow and comprises a fluid inlet, arranged to receive a fluid from the at least one fluid pipe 11, and at least one fluid outlet, arranged to direct the fluid towards at least one OAEHE, e.g., a radiator. The at least one impeller-motor device 10 is adapted to supply the fluid to the inlet of the first fluid discharge device 12 via the at least one fluid pipe 11 and cause the fluid to flow through the at least one fluid outlet of the first fluid discharge device 12 in a direction of the at least one OAEHE. The cooling arrangement 20 further comprises a second fluid discharge device 22 adapted to disturb the fluid that flows through the at least one fluid outlet of the first fluid discharge device 12. The cooling arrangement 20 may further comprise a funnel 15, e.g., a funnel duct with a Coanda border, to enhance the fluid flow. The operation of the cooling arrangement 20 is described below:

A generated fluid, e.g., airflow, may be brought, e.g., provided, to the impeller-motor device 10. The fluid may be filtered through a filter before being brought to the impeller-motor device 10.

The impeller-motor device 10 then supplies, e.g., accelerates, the fluid to the fluid pipe 11. The fluid pipe 11 may comprise a thermally insulated material. The impeller-motor device 10 may be located in a housing 16 at a distance from the at least one fluid discharge device 12. This distance between the impeller-motor device 10 and the at least one fluid discharge device 12 may be of at least 1 meter, 3 meters, 5 meters or more. According to some embodiments, the at least one impeller-motor device may be located in a housing at a distance of at least 3 meters from the at least one fluid discharge device. This distance between the impeller-motor device 10 and the at least one fluid discharge device 12 is advantageous, e.g., because sound from the impeller-motor device will be generated far away from the transformer making noise mitigation procedures possible, e.g., sound-shielded housing 16 and fluid pipes 11. By transferring the origin of sound to the sound-shielded housing, the fluid discharge device 12 operation may become noise reduced by 20 to 40 dB as compared to e.g., conventional bladed fans. The housing 16 may be sound shielded, thermally insulated, may comprise thermally insulating material, may be humidity controlled, may be dustproof and/or sound absorbing. The housing 16 and the at least one fluid pipe 11 may be located underground or covered by a strong structure, which can reduce the risk of vandalism and intentional attacks to the transformer plant. According to some embodiments, the cooling arrangement 20 may comprise a plurality of fluid pipes 11 that may be adapted to supply fluid to a plurality of first fluid discharge devices 12.

The fluid may be transported along the pipe 11 towards the inlet of the first fluid discharge device 12 with minimal pressure drop. The first fluid discharge device 12 may be arranged, e.g., fixated, in the funnel 15. The funnel 15 may comprise round smooth borders 18 at an inlet of the funnel 15 to facilitate a Coanda effect, which mitigates edge turbulence and reduces pressure drop at the inlet of the funnel 15. The inlet of the funnel 15 may comprise a filter grid 17. The filter grid 17 is used for preventing unwanted objects entering the OAEHE.

The fluid e.g., fluid flow such as air flow, may be forced to distribute at high pressure inside the first fluid discharge device 12.

The fluid is then discharged, e.g., ejected, at high speed, through the outlet of the first fluid discharge device 12. According to some embodiments the first fluid discharge device 12 comprises at least one slit and the fluid may be discharged through the slit which may be narrow, e.g., a slit that is designed to induce the flow towards the OAEHE.

Due to the high-speed of the fluid, the fluid in the back of the first fluid discharge device 12 may be induced into the central region of the first fluid discharge device 12. And nearby the outlet of the first fluid discharge device 12, fluid and/or humid fluid is entrained. The induction and entrainment, i.e., the Bernoulli effect, may multiply the initial fluid flow M by 10 to 50 times depending on the geometry and dimensions of the first fluid discharge device 12.

The aerodynamics shape of the toroid-like surface of the first fluid discharge device 12 and the Coandă effect enables the fluid flow to be directed towards the OAEHE.

The cooling arrangement 20 may further comprise a hose (not shown). The hose may be arranged to enhance and/or homogenize the supplied fluid. Additional fluid may be added to an axial region of the first fluid discharge device 12 and/or the second fluid discharge device 22 with the hose.

The obtained fluid flow may be increased to match the requirements to cool the at least one OAEHE in the transformer. A set of parameters may provide such a dedicated design. These parameters are:

a. Impeller-motor device power;

b. Fluid discharge device diameter and/or size;

c. Slit thickness;

d. Toroid-like shape of the first fluid discharge device 12 and cross-section dimensions of the first fluid discharge device 12. The first fluid discharge device 12 may be circular, oval, rectangular or any other polygonal shape.

According to some embodiments, colder fluid may be injected through the first fluid discharge device 12, which causes a significant enhancement of the external cooling.

High speed fluid may pass through the OAEHE, which geometrical shape will produce a pressure drop. The remaining fluid flow may be utilized to cool down a second or more OAEHEs.

The result of the cooling arrangement 20 operation is the multiplication of the fluid flow, typically by a factor of 10 to 50. The technology of the cooling arrangement 20 may utilize the surrounding fluid and/or humid fluid, to amplify the fluid flow that is transported to the first fluid discharge device 12. It is concluded that the cooling arrangement 20 effectively provides a powerful and efficient bulk fluid flow to at the least one OAEHE of the transformer. Furthermore, as fluid humidity, e.g., wet/moist cooling air flow, may be used for transformer external cooling, the heat transfer between the cooling fluid and the OAEHE of the transformer may be greatly enhanced. By using Bernoulli multiplier technology, the external cooling of power transformers may thus be enhanced.

However, the first fluid discharge device 12 comprising the fluid outlet may not provide a uniform flow to cool all the hot surfaces of the OAEHE. Assuming first fluid discharge device 12 is a ring, the generated fluid then may have approximately a cylindrical shape with low speed in the core and much higher speed at the edges. The cooling pattern will be far from being uniform with some areas of the OAEHE having high heat transfer coefficient and other areas not at all. Areas of the OAEHE submitted to very low air speed may not perform sufficient cooling and hot oil may be re-injected to the transformer tank. The cooling arrangement 20 therefore further comprises the second fluid discharge device 22 adapted to disturb the fluid that flows through the at least one fluid outlet of the first fluid discharge device 12. The second fluid discharge device 22 may disturb the fluid that flows through the at least one fluid outlet of the first fluid discharge device 12 by destabilizing and/or widen the fluid by applying a cross flow jet, e.g., cross jet or control jet. This is advantageous as the fluid velocity differences of the fluid that flows from the first discharge device 12 is reduced and an improved redistribution of the fluid flow is allowed. According to some embodiments, the applied cross flow jet may be continuous and according to some embodiments, the applied cross flow jet may be pulsating. The continuous jet is preferred in situations where steady operating conditions are required to guarantee a certain level of cooling process stability. The pulsating jet is utilized in dynamic situations to ensure high oscillation level of the jet as well as to substantially reduce energy consumption.

The at least one impeller-motor device 10 may be adapted to supply the fluid to the second discharge device 22. The at least one impeller-motor device 10 may be adapted to supply the fluid to the inlet of the first fluid discharge device 12, and/or to the second fluid discharge device 22, via the at least one fluid pipe 11 and/or via a second fluid pipe. The at least one fluid pipe 11 and/or the second fluid pipe may comprise a thermally insulated material. The second fluid discharge device 22 may be located between the first fluid discharge device 12 and the at least one OAEHE. The second fluid discharge device 22 may be arranged in the funnel 15.

According to some embodiments, a diameter of the second fluid discharge device 22 may be smaller than or the same size as a diameter of the first fluid discharge device 12, and wherein the cross flow jet is applied outwards from the second fluid discharge device 22.

According to some embodiments, a diameter of the second fluid discharge device 22 may be larger than a diameter of the first fluid discharge device 12, and wherein the cross flow jet is applied inwards of the second fluid discharge device 22.

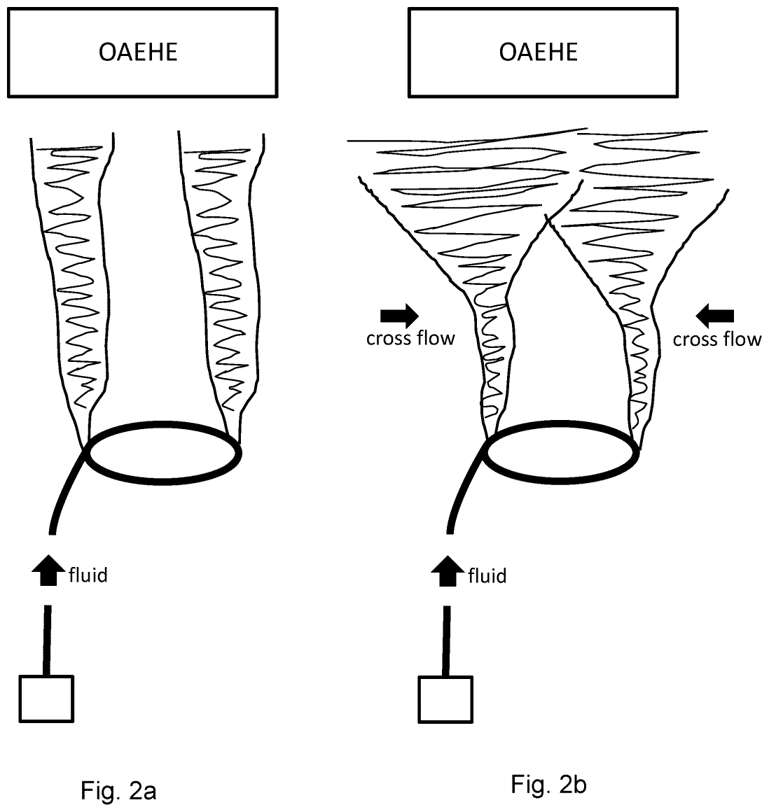

FIG. 2a illustrates a schematic overview according to an example of when the fluid flows from the first fluid discharge device 12 without any disturbance of the fluid. FIG. 2b illustrates a schematic overview of the fluid that flows from the first fluid discharge device 12 with disturbance of the fluid from the second fluid discharge device 22, according to an example of embodiments herein. By applying an optimized cross flow jet, the fluid from the first fluid discharge device 12 will be modified, broken in many transient eddies, or just widened. This reduces the fluid velocity differences, e.g., gradients, and allows a better redistribution of the flow and more accurately cool the surfaces of the OAEHE. The cross flow characteristics may be identified by computational fluid dynamic simulations and other optimization methods. To avoid that the fluid released by the outlet of the first fluid discharge device remains sharp while impinging on the OAEHE, a continuous or pulsating cross-jet through the second fluid discharge device 22, or separated pipes, hitting perpendicular or inclined the first fluid discharge device 12. The impact is to widen the fluid from the first fluid discharge device 12 and/or to destabilize it to e.g., become moving or pulsating in a way to cover all, or most of, the OAEHE surfaces with sufficient velocities able to create the desired cooling performance.

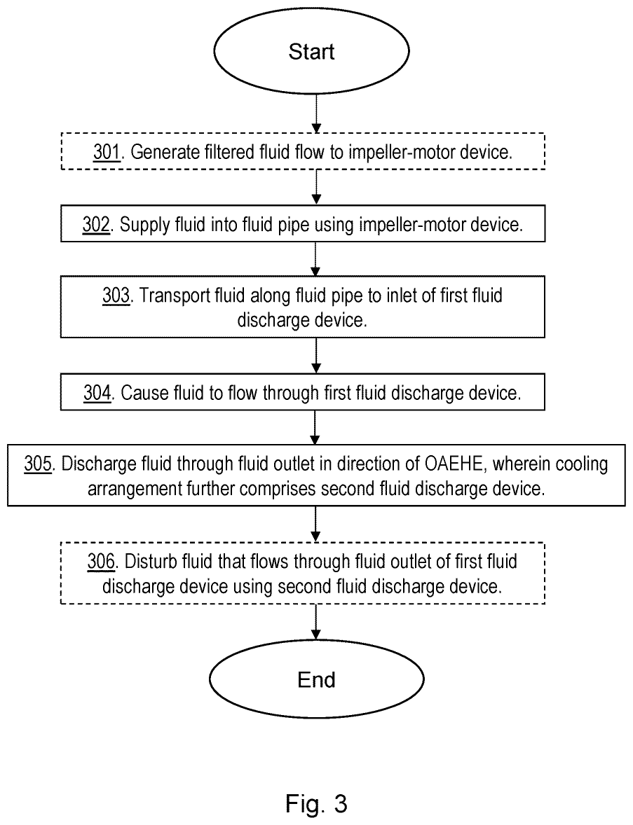

The method actions performed by the cooling arrangement 20 for cooling the at least one OAEHE in the transformer, according to embodiments herein, will now be described with reference to a flowchart depicted in FIG. 3. The actions do not have to be taken in the order stated below but may be taken in any suitable order. Actions performed in some embodiments are marked with dashed boxes. The cooling arrangement 20 comprises at least one impeller-motor device 10, at least one fluid pipe 11 and at least one fluid discharge device 12. The fluid discharge device 12 comprises the fluid inlet for receiving fluid from the at least one fluid pipe 11, and the at least one fluid outlet.

### Action 301

A filtered fluid may be generated and provided to the at least one impeller-motor device 10. The filter is to avoid having dust and/or particles into the at least one impeller-motor device 10 and through the at least one fluid pipe 11 and the first fluid discharge device 12. The at least one impeller-motor device 10 may be located in the housing 16. The housing 16 may be one or more of: sound-shielded, thermally insulated, comprises thermally insulating material, humidity controlled, dustproof and/or sound absorbing.

### Action 302

The cooling arrangement 20 supplies the fluid into the at least one fluid pipe 11, using the at least one impeller-motor device 10.

The at least one fluid pipe 11 may comprise a thermally insulated material. The cooling arrangement 20 may comprise a plurality of fluid pipes 11 that may be adapted to supply fluid to a plurality of first fluid discharge devices 12.

### Action 303

The cooling arrangement 20 transports the fluid along the at least one fluid pipe 11 to the inlet of the first fluid discharge device 12. The first fluid discharge device 12 may be circular, oval, rectangular or any other polygonal shape. The fluid outlet of the first fluid discharge device 12 may follow the outer perimeter or inner perimeter of the first fluid discharge device 12. The cooling arrangement 20 may comprise the funnel 15 and the first fluid discharge device 12 may be arranged in the funnel 15. The funnel 15 may comprise round smooth borders 18 at an inlet of the funnel 15 to facilitate a Coandă effect, which mitigates edge turbulence and reduces pressure drop at the inlet of the funnel 15.

### Action 304

The cooling arrangement 20 causes the fluid to flow through the first fluid discharge device 12.

### Action 305

The cooling arrangement 20 discharges, e.g., emits, the fluid through the at least one fluid outlet in a direction of the at least one OAEHE. The first fluid discharge device 12 may comprise at least one slit that is designed to be so narrow as to alter a recited physical property of the fluid stream by a recited amount due to the Bernoulli effect and the cooling arrangement 20 may discharge the fluid through the slit in the direction of the at least one OAEHE to cool down the at least one OAEHE. The cooling arrangement 20 further comprises the second fluid discharge device 22. The second fluid discharge device 22 may be located between the first fluid discharge device 12 and the at least one OAEHE. According to some embodiments, the at least one impeller-motor device 10 may be adapted to supply the fluid to the second discharge device 22. According to some embodiments, the diameter of the second fluid discharge device 22 may be smaller than the diameter of the first fluid discharge device 12, and wherein the cross flow jet may be applied outwards from the second fluid discharge device 22. According to some embodiments, the diameter of the second fluid discharge device 22 may be larger than the diameter of the first fluid discharge device 12, and wherein the cross flow jet may be applied inwards of the second fluid discharge device 22. The at least one impeller-motor device 10 may be adapted to supply the fluid to the inlet of the first fluid discharge device 12 and/or the second discharge device 22, via the at least one fluid pipe 11 or via a second fluid pipe. The at least one fluid pipe 11 and/or the second fluid pipe may comprise a thermally insulated material. By providing the second fluid discharge device 22 that disturbs the fluid that flows from the first fluid discharge device 12, fluid velocity differences of the fluid that flows from the first discharge device is reduced and an improved redistribution of the fluid flow is allowed.

### Action 306

The fluid that flows through the at least one fluid outlet of the first fluid discharge device 12 is disturbed, using the second fluid discharge device 22. According to some embodiments, disturbing the fluid that flows through the at least one fluid outlet of the first fluid discharge device 12 may comprise destabilizing and/or widen the fluid by applying a cross flow jet. According to some embodiments, the applied cross flow jet may be continuous. According to some embodiments, the applied cross flow jet may be pulsating. The cooling arrangement 20 may add additional fluid to an axial region of the first discharge device 12 and/or the second fluid discharge device 22 with the hose. The first fluid discharge device 12 and the second fluid discharge device 22 may be circular, oval, rectangular or any other polygonal shape.

Consequently, embodiments herein thus provide the cooling arrangement 20 comprising the at least one connected impeller-motor device 10, fluid pipe 11, the first fluid discharge device 12 ejecting a powerful fluid flow, and the second fluid discharge device 22 that disturbs the fluid of the first fluid discharge device 12. The impeller-motor device 10 may be located inside a housing 16 which may be protective and sound-shielded, and/or may be a thermally insulated, humidity controlled, dustproof and sound absorbing chamber. The fluid pipe 11 may be made of a robust and thermally insulating material. Examples of robust and thermally insulated materials are polymer composites which may include reinforcement such as carbon fibre. For robustness the fluid pipe 11 may also be made of metal covered by concrete. The fluid outlet of the discharge device 12 may follow the outer perimeter of the discharge device 12. The fluid discharge device 12 outlet may comprise a narrow slit, where fluid humidity exits and points towards the device to be cooled. Embodiments herein provide external cooling to large power transformers. The proposed cooling arrangement 20 is simple, lightweight, and easy to maintain. It is also silent as it has no moving parts at the cooling site. The latter is possible due to the separation of the fluid discharge device 12 from the impeller-motor device 10 which may be confined in a housing which may be sound-shielded. Embodiments herein are based on the Bernoulli principle, which makes it possible to multiply by more than one order of magnitude of the inlet fluid flow rate provided by the impeller-motor device 10. Embodiments herein are further based on using a second fluid discharge device 22 to disturb the fluid that flows from the first fluid discharge device 12.

It is to be noted that any feature of any of the aspects may be applied to any other aspect, wherever appropriate. Likewise, any advantage of any of the aspects may apply to any of the other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

It will be appreciated that the foregoing description and the accompanying drawings represent non-limiting examples of the method taught herein. As such, techniques taught herein are not limited by the foregoing description and accompanying drawings. Instead, the embodiments herein are limited only by the following claims and their legal equivalents.

1. A cooling arrangement for cooling at least one oil-to-air external heat exchanger, OAEHE, in a transformer, wherein the cooling arrangement comprises:
at least one impeller-motor device;
at least one fluid pipe; and
a first fluid discharge device, wherein the first fluid discharge device comprises a fluid inlet arranged to receive a fluid from the at least one fluid pipe, and at least one fluid outlet arranged to direct the fluid towards the OAEHE, wherein the at least one impeller-motor device is adapted to supply the fluid to the inlet of the first fluid discharge device via the at least one fluid pipe and cause the fluid to flow through the at least one fluid outlet of the first fluid discharge device in a direction of the at least one OAEHE, and wherein the cooling arrangement further comprises a second fluid discharge device adapted to disturb the fluid that flows from the at least one fluid outlet of the first fluid discharge device.

2. The cooling arrangement according to claim 1, wherein the second fluid discharge device disturbs the fluid that flows from the at least one fluid outlet of the first fluid discharge device by destabilizing and/or widen the fluid by applying a cross flow jet.

3. The cooling arrangement according to claim 2, wherein the applied cross flow jet is continuous.

4. The cooling arrangement according to claim 2, wherein the applied cross flow jet is pulsating.

5. The cooling arrangement according to claim 1, wherein the at least one impeller-motor device is adapted to supply the fluid to the second discharge device.

6. The cooling arrangement according to claim 1, wherein the second fluid discharge device is located between the first fluid discharge device and the at least one OAEHE.

7. The cooling arrangement according to claim 2, wherein a diameter of the second fluid discharge device is smaller than a diameter of the first fluid discharge device, and wherein the cross flow jet is applied outwards from the second fluid discharge device.

8. The cooling arrangement according to claim 2, wherein a diameter of the second fluid discharge device is larger than a diameter of the first fluid discharge device, and wherein the cross flow jet is applied inwards of the second fluid discharge device.

9. The cooling arrangement according to claim 1, wherein the first fluid discharge device and the second fluid discharge device is circular, oval, rectangular or any other polygonal shape.

10. The cooling arrangement according to claim 1, further comprises a hose that is arranged to enhance and/or homogenize the supplied fluid.

11. The cooling arrangement according to claim 1, wherein the cooling arrangement comprises a funnel.

12. The cooling arrangement according to claim 11, wherein the at least one fluid discharge device and/or the second fluid discharge device is arranged in the funnel.

13. Method performed by a cooling arrangement for cooling at least one oil-to-air external heat exchanger, OAEHE, in a transformer, wherein the cooling arrangement comprises at least one impeller-motor device, at least one fluid pipe and a first fluid discharge device comprising a fluid inlet for receiving a fluid from the at least one fluid pipe, and at least one fluid outlet, the method comprising:
supplying the fluid into the at least one fluid pipe, using the at least one impeller-motor device;
transporting the fluid along the at least one fluid pipe to the inlet of the first fluid discharge device;
causing the fluid to flow through the first fluid discharge device;
discharging the fluid from the at least one fluid outlet in a direction of the at least one OAEHE, wherein the cooling arrangement further comprises a second fluid discharge device, and wherein the method further comprises:
disturbing the fluid that flows from the at least one fluid outlet of the first fluid discharge device, using the second fluid discharge device.

14. The method according to claim 13, wherein disturbing the fluid that flows from the at least one fluid outlet of the first fluid discharge device comprises destabilizing and/or widen the fluid by applying a cross flow jet.

15. The method according to claim 13, further comprises:
generating a filtered fluid to the at least one impeller-motor device.
